(19) United States
(12) Patent Application Publication
(10) Pub. No.: US 2022/0090834 A1
(43) Pub. Date: Mar. 24, 2022

(54) METHOD OF CONTROLLING REFRIGERATOR

(71) Applicant: LG ELECTRONICS INC., Seoul (KR)

(72) Inventors: Hyunwoo DO, Seoul (KR); Heekwon RYU, Seoul (KR); Gyudong LEE, Seoul (KR); Hwanyoung KIM, Seoul (KR)

(73) Assignee: LG ELECTRONICS INC.

(21) Appl. No.: 17/474,279

(22) Filed: Sep. 14, 2021

(30) Foreign Application Priority Data
Sep. 24, 2020 (KR) 10-2020-0124000

(51) Int. Cl. F25B 49/02; F25B 31/00; F25D 29/00

(52) U.S. Cl. CPC F25B 49/022; F25B 2600/0253; F25D 29/00; F25B 31/002

(57) ABSTRACT

A refrigerator includes a temperature sensor provided in a storage space of the refrigerator to detect a temperature; an inverter compressor constituting a freezing cycle for cooling the storage space, the number of rotations being variable by frequency control; and a controller for controlling the operation of the inverter compressor. The controller may variably control the operating frequency of the inverter compressor according to the load of the storage space in order to maintain the storage space at a set temperature, and compare the operating frequency with a stop frequency when a stop signal is input, when the operating frequency is lower than the stop frequency, raise the frequency of the inverter compressor to the stop frequency, and then stop the inverter compressor.

### CROSS-REFERENCE TO RELATED APPLICATION

The present application claims priority under 35 U.S.C. 119 and 35 U.S.C. 365 to Korean Patent Application No. 10-2020-0124000, filed in Korea on Sep. 24, 2020, the disclosure of which is hereby incorporated by reference in its entirety.

### BACKGROUND

### 1. Field

The present invention relates to a method of controlling a refrigerator.

### 2. Background

In general, refrigerators are home appliances that allow low-temperature storage of food in an internal storage space that is shielded by a door. To this end, the refrigerator is configured to store the stored food in an optimal state by cooling the interior of the storage space using cold air generated through heat exchange with a refrigerant circulating through a freezing cycle.

Recent refrigerators have been developed to configure a freezing cycle using an inverter compressor capable of effectively responding to a cooling performance according to a load to improve cooling performance and significantly reducing power consumption. In addition, a frequency of the inverter compressor can be adjusted according to a temperature in the refrigerator, and the operation of the inverter compressor is controlled in a variable frequency control method, thereby improving cooling efficiency. Meanwhile, the inverter compressor may be turned on and off when the refrigerator is being driven, and noise may occur during a process of turning on/off the inverter compressor.

A representative example of the prior art for preventing a starting noise of the inverter compressor is disclosed in Korean Patent Registration No. 10-0301499. The prior art discloses a method of setting a lubrication mode of an inverter compressor of a refrigerator, by which a starting noise is reduced by allowing the inverter compressor to slowly rotate in a lubrication mode at or below a resonance frequency before the inverter compressor reaches a target rotational speed during operation of the inverter compressor. On the other hand, it can be seen from the prior art that the operation for reducing the noise when the inverter compressor is stopped is not disclosed.

When the inverter compressor is operated at a low operating frequency because a temperature in the refrigerator is set to a relatively high temperature, there is a problem in which noise occurs when the inverter compressor is stopped while rotating at a low speed. In detail, when a stop signal is input or a stop condition occurs while the inverter compressor is rotating at a low speed, a motor, the inverter compressor is stopped in a state in which the inertial force of a piston, and the like constituting the inverter compressor is reduced, so that components such as the motor and the piston in the compressor may cause a noise due to collision and friction during the process of stopping the inverter compressor. In particular, the inverter compressor provided in the refrigerator has a very compact structure to minimize the internal structure of the machine room, thereby causing a problem in which noise occurs more frequently and becomes larger when the inverter compressor is stopped.

### BRIEF DESCRIPTION OF THE DRAWINGS

Embodiments will be described in detail with reference to the following drawings in which like reference numerals refer to like elements, and wherein:

FIG. 1 is a perspective view of a refrigerator according to an embodiment of the present disclosure as viewed from the rear;

FIG. 2 is a block diagram showing a flow of control signals between main components of the refrigerator;

FIG. 3 is a flowchart illustrating a process of operating the compressor;

FIG. 4 is a graph showing a change in frequency when the inverter compressor of the refrigerator is stopped at an operating state in which the operating frequency is higher than the stop frequency;

FIG. 5 is a view showing a change in noise of the refrigerator in the operating state as shown in FIG. 4;

FIG. 6 is a graph showing a change in frequency when the inverter compressor of the refrigerator is stopped at an operating state in which the operating frequency is lower than the stop frequency;

FIG. 7 is a view showing a change in noise of the refrigerator in the operating state as shown in FIG. 6; and

FIG. 8 is a graph showing a change in noise of a refrigerator of a comparative example.

### DETAILED DESCRIPTION

Hereinafter, specific embodiments of the present disclosure will be described in detail with reference to the drawings. However, the present disclosure cannot be said to be limited to the embodiments in which the spirit of the present disclosure is presented, and other inventions that are degenerate by addition, changes, deletions, etc. of other elements or other embodiments included within the scope of the present disclosure are easy can suggest

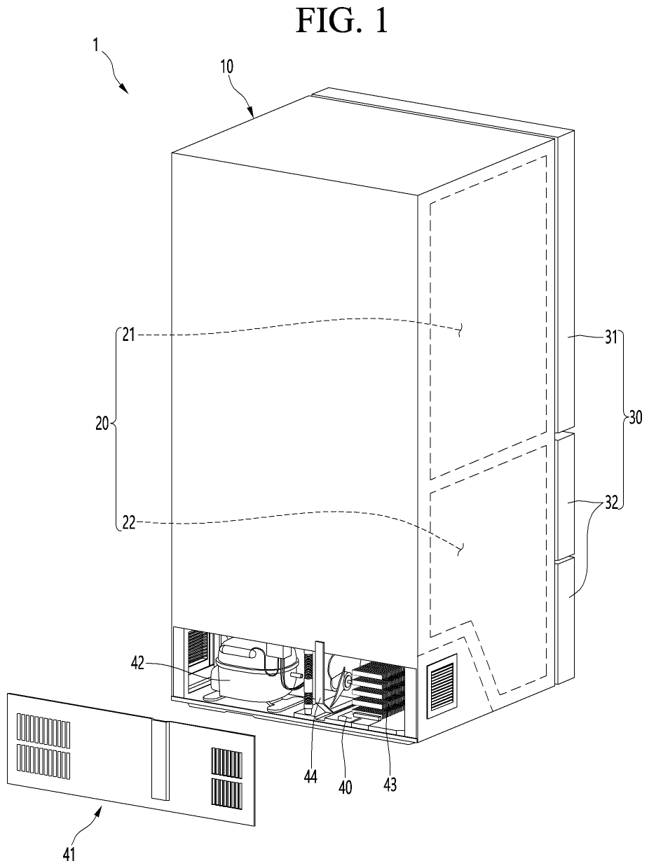

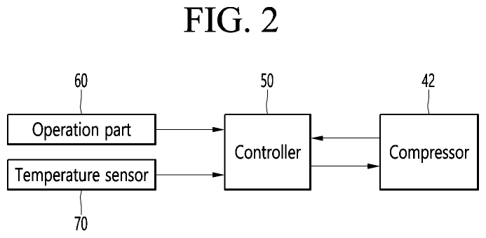

FIG. 1 is a perspective view of a refrigerator according to an embodiment of the present disclosure as viewed from the rear. FIG. 2 is a block diagram showing the flow of control signals between main components of the refrigerator. As illustrated in FIGS. 1 and 2, a refrigerator 1 according to an embodiment of the present disclosure may include a cabinet 10 defining a storage space, and a door 30 for opening and closing the cabinet 10. In addition, a machine room 40 may be provided at a lower end of the rear surface of the cabinet 10.

The storage space 20 may include a refrigerating chamber 21 or a freezing chamber 22, and may include any one of the refrigerating chamber 21 or the freezing chamber 22. In addition, the storage space 20 may maintain various temperature ranges according to a type and state of the food stored.

The door may include a refrigerating chamber door 31 and a freezing chamber door 32 for opening and closing the refrigerating chamber 21 and the freezing chamber 22, respectively. In addition, the door 30 may be configured to open and close the storage space 20 in a rotation or drawer manner.

The machine room 40 may be opened to the rear, and a compressor 42, a condenser 43, a heat dissipation fan 44, and the like constituting a freezing cycle may be provided in the machine room 40. In addition, the rear surface of the machine room 40 may be shielded by a grill fan 41 formed with an air inlet and an air outlet. In addition, although not shown, an evaporator (not shown), which is one component of the freezing cycle, may be disposed in the refrigerator, compressed supply of high-temperature and high-pressure refrigerant is possible by the operation of the compressor 42, and the storage space is cooled by the cold air, which has been heat-exchanged with the refrigerant inside the evaporator.

The compressor 42 may have a structure in which the speed is variable according to the load in the refrigerator, and the refrigerant capacity is varied and compressed and supplied, and may be referred to as an inverter compressor 42. That is, when the temperature in the refrigerator is high, the rotational speed of the inverter compressor 42 is raised to supply a larger amount of refrigerant, and when the temperature in the refrigerator is relatively low, the rotational speed of the inverter compressor 42 is lowered to supply a smaller amount of refrigerant. That is, the cooling power of the inverter compressor 42 may be adjusted according to the temperature in the refrigerator to provide an appropriate cooling power required to cool the inside of the refrigerator.

As described above, the rotation speed of the inverter compressor 42 may be adjusted in such a way that the controller 50 controls the operating frequency. That is, when the operating frequency of the inverter compressor 42 is controlled to be high, the inverter compressor 42 is rotated at a high speed to discharge a larger amount of refrigerant. When the operating frequency of the inverter compressor 42 is controlled to be relatively low, the inverter compressor 42 is rotated at a relatively low speed to discharge a relatively small amount of refrigerant. For example, the inverter compressor 42 may be controlled at a frequency between 0 Hz and 70 Hz, and may be variably controlled to an appropriate frequency according to a change in an load of the inside of the refrigerator or a user's operation.

In order to control the storage space 20 to a set temperature, the storage space 20 may be provided with a temperature sensor 70 for detecting a temperature of the storage space. Accordingly, the temperature of the storage space 20 detected by the temperature sensor 70 may be transmitted to the controller, and the controller may determine the operating frequencies (or second frequencies) F1 and F2 of the inverter compressor 42 by comparing the detected temperature with a set temperature.

The refrigerator 1 may include an operation part (or input device) 60. The operation part 60 may control the operation of the refrigerator 1 according to a user's input. That is, the user may set a target temperature of the storage space 20 by operating the operation part 60. In addition, an operation mode may be set through an operation through the operation part 60.

For example, the refrigerator 1 may store various foods, but may also control the operation of the refrigerator 1 at a temperature suitable for storing kimchi. When a kimchi operation mode is selected by operation through the operation part 60, the storage space 20 may be controlled at a temperature between 0° C. and 9° C. Of course, the set temperature of the storage space 20 may be set in a manner in which temperatures are subdivided through the operation part 60 according to a desired storage state of the kimchi.

As described above, the user may select to operate the storage space 20 at a set temperature or a set temperature range by operating the operation part 60. In addition, the controller 50 may operate the inverter compressor 42 by controlling a frequency of the inverter compressor 42 so as to maintain a temperature and a temperature range set by the operation part 60.

On the other hand, the refrigerator 1 is continuously powered such that the inside of the storage space 20 is always at a set temperature or temperature range, and the driving and stopping of the inverter compressor 42 may be repeated. Accordingly, noise may occur when the inverter compressor 42 is driven, and an operation to minimize noise may be required because the refrigerator 1 is disposed indoors. In particular, in order to minimize noise that may occur when the inverter compressor 42 is stopped, the controller 50 may perform a stop operation of the inverter compressor 42.

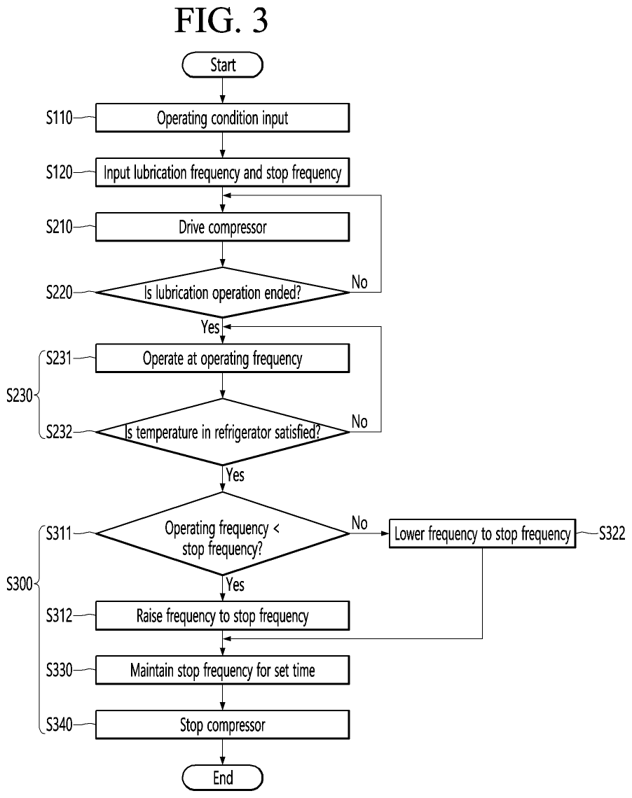

Hereinafter, a process of operating the inverter compressor 42 will be described in more detail with reference to the drawings. FIG. 3 is a flowchart illustrating a process of operating the compressor.

As shown in the drawing, in a state in which the operation of the refrigerator 1 is started, an operating condition may be input to drive the compressor. In this case, the operating condition may be automatically input according to a temperature set by the controller 50 in advance or a change in temperature. When a user inputs a specific operation through the operation part 60 while the refrigerator 1 is being operated, a suitable operating condition may be set again and input to the controller 50.

For example, the user may input a kimchi storage mode through the operation part 60 to store kimchi in the refrigerator 1. The controller 50 may set operating conditions such that a temperature of the storage space 20 reaches a suitable temperature (0° C. to 9° C.) for storing kimchi according to the input of the kimchi storage mode. The controller 50 may calculate the operating frequencies F1 and F2 of the inverter compressor 42 corresponding to the set operating conditions, and allow the inverter compressor 42 to be operated according to the calculated operating frequencies F1 and F2. [S110: Operating condition input step]

When an operating condition is input to the controller 50, the controller 50 may provide lubrication frequencies (or first frequencies) FL1 and FL2 for starting the inverter compressor 42. In addition, the controller may further provide a stop frequency (or third frequency) Fs required when the inverter compressor 42 is stopped. The lubrication frequencies FL1 and FL2 may be applied to the lubrication operation of the inverter compressor 42 that is performed before entering the operating frequencies F1 and F2 after the inverter compressor 42 is initially started. The lubrication operation is to supply oil by the centrifugal force of a lubrication pump connected to a rotating shaft of the inverter compressor 42, and may facilitate driving of the inverter compressor 42 more smoothly.

The lubrication frequencies FL1 and FL2 may be set to frequencies at which supply of oil is most efficient according to the specifications of the inverter compressor 42. For example, the lubrication frequencies FL1 and FL2 may be set to an appropriate value between 20 Hz and 50 Hz, or may be set to gradually change in a section of 20 Hz to 50 Hz.

The stop frequency Fs may be applied to a stop operation for stopping the inverter compressor 42. When the temperature of the storage space 20 satisfies the set temperature, the inverter compressor 42 may perform a stop operation. The stop operation is an operation for reducing noise when the inverter compressor 42 is stopped, and internal components such as a motor and a piston constituting the inverter compressor 42 have appropriate inertia to minimize occurrence of noise caused by friction or collision when the inverter compressor 42 is stopped.

The stop frequency Fs may be set to the lowest frequency as possible within a range capable of securing the inertia with which the components moving inside the inverter compressor 42 can be stopped without causing noise according to the specifications of the inverter compressor 42. For example, the stop frequency Fs may be set to a value between 15% and 40% of the lower limit of the entire frequency range of the inverter compressor 42. Also, the stop frequency Fs may be set to a value between 10 Hz and 20 Hz. In addition, the stop frequency Fs may be set lower than the lubrication frequencies FL1 and FL2.

The lubrication frequencies FL1 and FL2 and the stop frequency Fs may be stored in the controller 50 as fixed values regardless of operating conditions, and may be specified to a value or a range set according to the specifications of the inverter compressor 42. That is, the lubrication frequencies FL1 and FL2 and the stop frequency Fs may be maintained at a set value or range regardless of a change in the operating state of the inverter compressor 42. [S120: Frequency input step]

When the input of the operating conditions for driving the inverter compressor 42 and the input of the lubrication frequencies FL1 and FL2 and the stop frequency Fs are completed, the driving of the inverter compressor 42 may be started. [S210: Compressor driving step]

After the driving of the inverter compressor 42 is started, the controller 50 may allow the inverter compressor 42 to perform lubrication operation. The controller 50 may allow the inverter compressor 42 to perform lubrication operation at the lubrication frequencies FL1 and FL2 for a sufficient time to enable supply of oil to be sufficiently achieved and allow the inverter compressor 42 to be smoothly operated in the case of load-response operation.

The controller 50 may allow the lubrication operation of the inverter compressor 42 to be performed for a set time or operate the inverter compressor 42 at the lubrication frequencies FL1 and FL2 until the set lubrication frequencies FL1 and FL2 have been reached. Then, when the lubrication operation has been performed for the set time or the set lubrication frequencies FL1 and FL2 have been reached, the controller 50 may determine the end of the lubrication operation. [S220: Lubrication operation step]

When the lubrication operation is terminated, the controller 50 may control the inverter compressor 42 at the operating frequencies F1 and F2 such that the inverter compressor 42 performs the load-response operation. The load-response operation may be performed in a way that the controller variably controls the frequency of the inverter compressor 42 according to the load of the storage space 20. That is, the controller 50 may adjust the operating frequencies F1 and F2 of the inverter compressor 42 such that the storage space 20 maintains the set temperature or a set temperature input by the operation part 60 or the temperature sensor 70.

The load-response operation will be described below in more detail. After the lubrication operation is completed, the controller 50 may operate the inverter compressor 42 at a corresponding operating frequency F1 or F2 according to a load of the storage space 20. In this case, when the difference between the temperature of the storage space 20 and the set temperature is large, the operating frequency F1 of the inverter compressor 42 may be raised, and when the difference between the temperature of the storage space 20 and the set temperature is relatively small, the operating frequency F2 of the inverter compressor 42 may be lowered. [S231] In addition, the temperature sensor 70 may continuously detect the temperature of the storage space 20, and perform comparison whether the storage space 20 has reached a set temperature or temperature range to satisfy the set temperature or temperature range. [S232]

When the temperature of the storage space 20 has reached the set temperature or the set temperature range, the controller 50 may input a stop signal for stopping the inverter compressor 42 to the inverter compressor 42 to end the load-response operation step. [S230: Load-response operation step]

Then, the controller 50 may perform a stop operation at the same time as the end of the load response operation step. The stop operation will be described below in more detail. In the case of the end of the load-response operation, the controller 50 may compare the operating frequencies F1 and F2 at the end of the load-response operation with the stop frequency Fs. [S311]

In particular, in a case where the operating frequency F2 is lower than the stop frequency Fs, when the inverter compressor 42 is stopped at the operating frequency F2 according to input of the stop signal to the inverter compressor 42, the inertial force of the internal components of the inverter compressor 42 is insufficient, and consequently, noise due to friction or impact of the internal components of the inverter compressor 42 is greatly caused. Accordingly, when the operating frequency F2 of the inverter compressor 42 is lower than the stop frequency Fs, the controller 50 may raises the frequency of the inverter compressor 42 to the stop frequency Fs. [S312]

In addition, the controller 50 may maintain the stop frequency Fs for a set time S when the frequency of the inverter compressor 42 has reached the stop frequency Fs. In this case, the set time S may be set to a time for which an inertial force capable of minimizing friction and impact during a stop process of the internal components of the inverter compressor 42 is secured. When the set time S is too short, an appropriate inertial force may not be secured, resulting in occurrence of noise, and when the set time S is too long, the storage space 20 may be overcooled. For example, the set time S may be set to 3 seconds to 10 seconds. [S330]

Furthermore, when the set time has elapsed while the inverter compressor 42 is raised to the stop frequency Fs, the controller 50 may stop the inverter compressor 42. [S340] As described above, in a situation in which the inverter compressor 42 is operated at an operating frequency F1 lower than the stop frequency Fs to cause occurrence of noise when the inverter compressor 42 is stopped, the internal components of the inverter compressor 42 may secure an inertial force capable of minimizing friction or collision in the case of stopping the inverter compressor 42 through the stop operation to minimize the noise until the inverter compressor 42 is stopped. [S300: Stop operation step]

On the other hand, when the operating frequency F1 is higher than the stop frequency Fs in the step [S311] of comparing the operation frequency F1 at the end of the load-response operation with the stop frequency Fs, the controller 50 may lower the frequency of the inverter compressor 42 to the stop frequency Fs in the case of inputting the stop signal. That is, even when the load-response operation is ended in a state where the operating frequency F1 is higher than the stop frequency Fs, the controller 50 may perform control such that the inverter compressor 42 is stopped at the stop frequency Fs in order to minimize occurrence of the noise in the inverter compressor 42. [S312] Then, the controller 50 may maintain the stop frequency Fs for the set time in a state where the frequency of the inverter compressor 42 has reached the stop frequency Fs [S330], and then the inverter compressor 42 may be stopped. [S340]

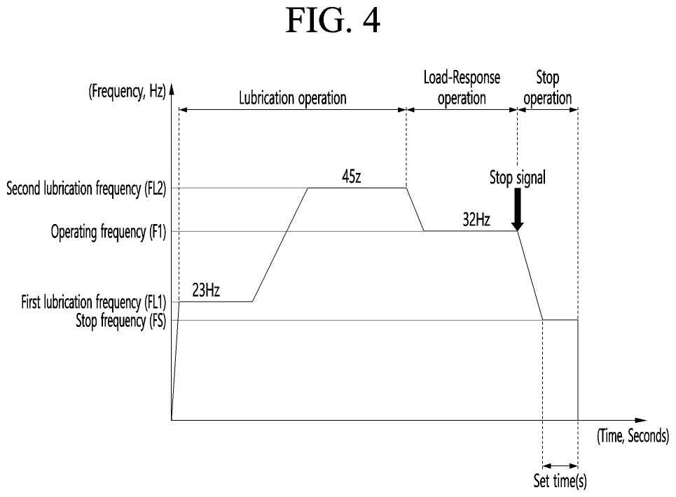

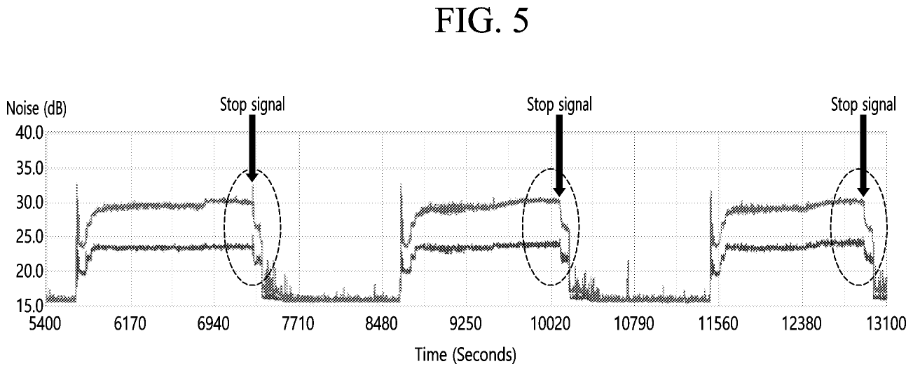

Hereinafter, the operation of the inverter compressor 42 and a change in noise will be described in more detail with reference to the drawings. FIG. 4 is a graph showing a change in frequency when the inverter compressor of the refrigerator is stopped at an operating state in which the operating frequency is higher than the stop frequency. Furthermore, FIG. 5 is a view showing a change in noise of the refrigerator in the operating state as shown in FIG. 4. As shown in the drawings, when the set temperature of the storage space 20 is low, for example, when the refrigerator 1 is operated in a freezing mode, the inverter compressor 42 may be controlled at a high operating frequency F1 while being rotated at a high speed.

In detail, when the inverter compressor 42 may perform a lubrication operation when starting to operate. In this case, the inverter compressor 42 may start the lubrication operation at a first lubrication frequency FL1 which has a relatively low frequency, operate at the first lubrication frequency FL1 for a predetermined time, and thereafter, the frequency of the inverter compressor 42 may be gradually raised to a second lubrication frequency FL2. When the frequency of the inverter compressor 42 has reached the second lubrication frequency FL2, the second lubrication frequency FL2 is maintained for a set time, so that lubricating oil in the inverter compressor 42 is sufficiently supplied. In this case, the first lubrication frequency FL1 may be 23 Hz, and the second lubrication frequency FL2 may be 45 Hz.

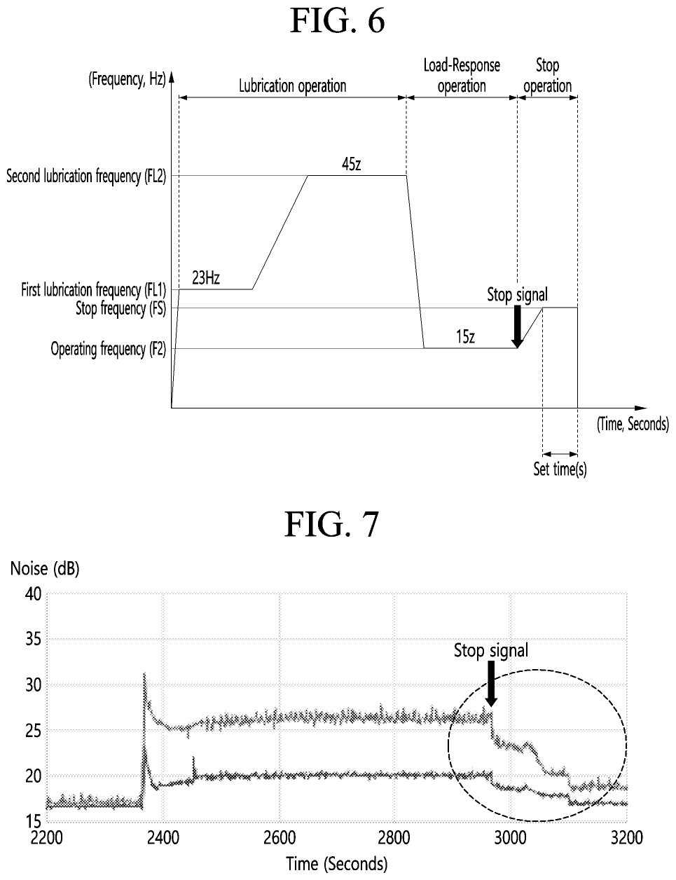

When the lubrication operation is ended, the controller 50 may control the inverter compressor 42 at an appropriate operating frequency F1 to perform a load-response operation. In this case, the operating frequency F1 may correspond to load response operation in a case where a relatively large cooling power is required, when compared to FIG. 6, such as when the operating frequency F1 is higher than the stop frequency Fs, and the load of the storage space 20 is large or when the refrigerator is operated in a freezing mode to cool the freezing chamber 22. For example, the operating frequency F1 may be 32 Hz.

Meanwhile, although only one operating frequency F1 is displayed in FIG. 4, the operating frequency F1 may be changed a plurality of times according to a change in load of the storage space 20 during the load-response operation, and even in this case, the operating frequency F1 immediately before the stop operation is greater than the stop frequency Fs. When the temperature of the storage space 20 reaches a set temperature or a set temperature range, the controller 50 may input a stop signal to end the load-response operation and perform the stop operation.

When the stop signal is input, the inverter compressor 42 may lower the frequency of the inverter compressor 42 to the stop frequency Fs. Then, the inverter compressor 42 is additionally operated for a set time in a state in which the frequency of the inverter compressor 42 is lowered to the stop frequency Fs. It is possible to secure an inertial force capable of minimizing friction and collision of the internal components of the inverter compressor 42, which may be caused when the inverter compressor 42 is stopped, through the stop operation to allow the inverter compressor 42 to be stopped in this state.

Meanwhile, FIG. 5 shows a graph showing a change in noise during operation of the refrigerator 1 due to the operation of the inverter compressor 42 as in FIG. 4, and it can be seen that noise occurs periodically during operation in the refrigerator 1. The noise of the refrigerator 1 may be divided into a front noise directed to the front and a rear noise directed to the rear. In addition, the machine room 40 in which the inverter compressor 42 is disposed is disposed on the rear side of the cabinet 10 and the rear noise is relatively greater than the front noise due to the air flow structure for cooling and heat dissipation of the machine room 40.

In addition, it can be seen that the change state in periodic noise of the refrigerator 1 coincides with the operation of the inverter compressor 42. It can be seen that starting noise occurs at an initial time when the inverter compressor 42 starts being driven, the noise constantly occurs during the operation of the inverter compressor 42, and the noise significantly decreases when the operation of the inverter compressor 42 is stopped. In particular, it can be seen from the portion shown in FIG. 6 that a stop noise hardly occurs through the stop operation as described above until the operation of the inverter compressor 42 is stopped from when the stop signal is input to the inverter compressor 42.

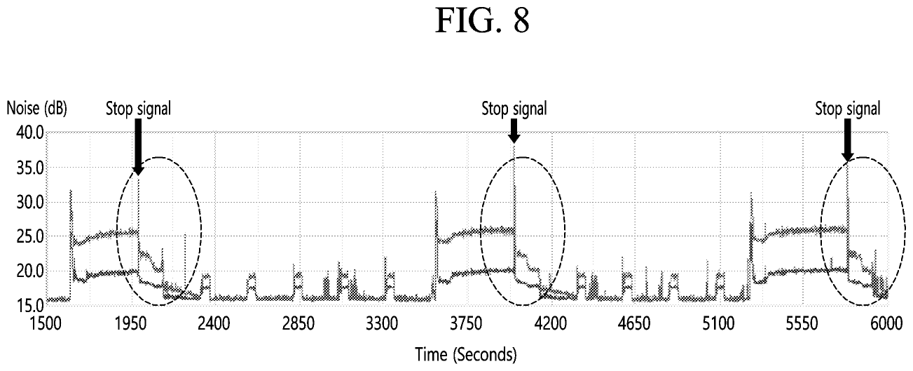

Meanwhile, FIG. 6 is a graph showing a change in frequency when the inverter compressor of the refrigerator is stopped at an operating state in which the operating frequency is lower than the stop frequency. Furthermore, FIG. 7 is a view showing a change in noise of the refrigerator in the operating state as shown in FIG. 6. In addition, FIG. 8 is a graph showing a change in noise of a refrigerator of a comparative example.

As shown in the drawings, when the set temperature of the storage space 20 is relatively high, for example, when the refrigerator 1 is operated in a refrigerating mode or a kimchi storage mode, the inverter compressor 42 may be controlled at a low operating frequency F2 while being rotated at a relatively low speed. In detail, when the inverter compressor 42 may perform a lubrication operation when starting to operate. In this case, the inverter compressor 42 may start the lubrication operation at a first lubrication frequency FL1 which has a relatively low frequency, operate at the first lubrication frequency FL1 for a predetermined time, and thereafter, the frequency of the inverter compressor 42 may be gradually raised to a second lubrication frequency FL2. When the frequency of the inverter compressor 42 has reached the second lubrication frequency FL2, the second lubrication frequency FL2 is maintained for a set time, so that lubricating oil in the inverter compressor 42 is sufficiently supplied. In this case, the first lubrication frequency FL1 may be 23 Hz, and the second lubrication frequency FL2 may be 45 Hz.

When the lubrication operation is ended, the controller 50 may control the inverter compressor 42 at an appropriate operating frequency F2 to perform a load-response operation. In this case, the operating frequency F2 is lower than the stop frequency Fs. When the operating frequency F2 is lower than the stop frequency Fs, the storage space 20 may be in a situation in which a small cooling power is required, such as a case in which the storage space 20 is operated in a refrigerating mode. As a more specific example, when the storage space 20 is operated at a temperature (0 ° C. to 9° C.) required for storage of kimchi because the storage space 20 is operated in a kimchi storage mode, the operating frequency F2 may be lower than the stop frequency Fs. That is, the case in which the operating frequency F2 is lower than the stop frequency Fs may correspond to a case in which a relatively smaller cooling power is required compared to that in FIG. 4, and for example, the operating frequency F2 may be 15 Hz.

On the other hand, although only one operating frequency F2 is displayed in FIG. 6, the operating frequency F2 may be changed a plurality of times according to a change in load of the storage space 20 during the load-response operation, and even in this case, the operating frequency F2 immediately before the stop operation is less than the stop frequency Fs. When the temperature of the storage space 20 reaches a set temperature or a set temperature range, the controller 50 may input a stop signal to end the load-response operation and perform the stop operation.

When the stop signal is input, the inverter compressor 42 may raise the frequency of the inverter compressor 42 to the stop frequency Fs. In addition, the inverter compressor 42 is additionally operated for a set time S in a state in which the frequency of the inverter compressor 42 is raised to the stop frequency Fs. It is possible to secure an inertial force capable of minimizing friction and collision of the internal components of the inverter compressor 42, which may be caused when the inverter compressor 42 is stopped, through the stop operation to allow the inverter compressor 42 to be stopped in this state.

Meanwhile, FIG. 7 shows a graph showing a change in noise during operation of the refrigerator 1 due to the operation of the inverter compressor 42 as in FIG. 6, and it can be seen that noise occurs periodically during operation in the refrigerator 1. The noise of the refrigerator 1 may be divided into a front noise directed to the front and a rear noise directed to the rear, and the machine room 40 in which the inverter compressor 42 is disposed is disposed on the rear side of the cabinet 10 and the rear noise is relatively greater than the front noise due to the air flow structure for cooling and heat dissipation of the machine room 40.

In addition, it can be seen that the change state in periodic noise of the refrigerator 1 coincides with the operation of the inverter compressor 42. It can be seen that starting noise occurs at an initial time when the inverter compressor 42 starts being driven from a stop state, the noise constantly occurs during the operation of the inverter compressor 42, and the noise significantly decreases when the operation of the inverter compressor 42 is stopped. In particular, it can be seen from the portion shown in FIG. 7 that a stop noise hardly occurs through the stop operation as described above until the operation of the inverter compressor 42 is stopped from when the stop signal is input to the inverter compressor 42.

Meanwhile, FIG. 8 shows a change in noise of a refrigerator when the inverter compressor 42 is controlled to be immediately stopped at an operating frequency F2 lower than the stop frequency Fs without performing the aforementioned stop operation.

When the inverter compressor 42 is stopped in a case where the operating frequency F2 of the inverter compressor 42 is lower than the stop frequency Fs, the internal components of the inverter compressor 42 is stopped while having no sufficient inertial force, causing noise due to friction and collision. Accordingly, it can be seen from FIG. 8 that a stop noise greatly occurs at the moment when a stop signal is input to the inverter compressor 42. That is, when FIG. 7 is compared with FIG. 8, it is possible to minimize the stop noise of the inverter compressor 42 by performing the stop operation, and in particular, it is possible to prevent the stop noise from occurring even when the operation frequency F2 of the inverter compressor 42 is less than the stop frequency Fs.

The following effects can be expected in the method for controlling the refrigerator according to the proposed embodiment. According to an embodiment of the present disclosure, when the cooling of the storage space is completed and the inverter compressor is stopped, the inverter compressor is switched to a stop frequency and then stopped. The stop frequency may be set to a value having an inertial force that minimizes friction and collision of the internal components of the inverter compressor when being stopped, thus minimizing the stop noise of the inverter compressor.

Accordingly, the overall operation noise of the refrigerator can be significantly reduced by minimizing the stop noise of the inverter compressor, which is the largest noise occurring during operation of the refrigerator. In particular, when the inverter compressor is operated at a frequency less than the stop frequency because the load of the storage space is small, such as in a kimchi storage mode or operation in a refrigeration operation region, it is inevitable that a stop noise occurs when inverter compressor is stopped, but it is possible to minimize the stop noise of the inverter compressor under any circumstances by raising the frequency to the stop frequency and then stopping the operation. That is, there is an advantage in that it is possible to effectively prevent noise that inevitably occurs due to the switch of operations that requires a change in temperature during storage of kimchi or refrigerating operation when the refrigerator is being operated.

In addition, the inverter compressor is additionally operated at the stop frequency for a set time in a state in which the inverter compressor has been switched to the stop frequency for stopping and is then is stopped. Accordingly, the internal components of the inverter compressor may be stabilized in a state of being provided with an appropriate inertial force when the inverter compressor is being additionally operated at the stop frequency, and thus the inverter compressor is stopped in such a state, thereby preventing noise more effectively.

An aspect of the present disclosure is to provide a method of controlling a refrigerator capable of reducing a stop noise of an inverter compressor. Another aspect of the present invention is to provide a method of controlling a refrigerator capable of reducing the stop noise of an inverter compressor during operation in a low-temperature refrigeration region. Still another aspect of the present invention is to provide a method of controlling a refrigerator capable of reducing the stop noise of an inverter compressor during operation for storage of kimchi.

According to an embodiment of the present disclosure, a method of controlling a refrigerator may include a lubrication operation step of operating an inverter compressor at a lubrication frequency after initiating the inverter compressor; a load-response operation step of controlling an operating frequency of the inverter compressor according to a load of a storage space of the refrigerator and operating the inverter compressor, and a stop operation step of comparing the operating frequency with a stop frequency when a stop signal is input, and then raising a frequency of the inverter compressor to a stop frequency and stopping the inverter compressor when the operating frequency is lower than the stop frequency.

The stop frequency may be set to a value between 15% and 40% of a lower limit of an entire frequency range of the inverter compressor. The stop frequency may be set to a value between 10 Hz and 20 Hz. The stop frequency may be set lower than the lower limit of the lubrication frequency.

The stop operation step may include additionally operating the inverter compressor for a set time at the stop frequency and then stopping the inverter compressor when the frequency of the inverter compressor has reached the stop frequency. The set time may be set between 3 seconds and 10 seconds.

The stop operation step may be performed when the stop signal is input while the storage space is subjected to refrigeration operation. The stop operation step may be performed when the stop signal is input while the temperature of the storage space is in a range of 0° C. to 9° C. The stop operation step may be performed when the stop signal is input while the refrigerator is operating in a kimchi storage mode.

The stop operation step may include a stop operation step of lowering the frequency of the inverter compressor to the stop frequency and stopping the inverter compressor when the operating frequency is higher than the stop frequency. The stop operation step may include additionally operating the inverter compressor for a set time at the stop frequency and then stopping the inverter compressor when the frequency of the inverter compressor has reached the stop frequency. The stop signal may be input when a temperature inside the refrigerator is satisfied.

The lubrication frequency and the stop frequency may be fixed regardless of an operating state of the refrigerator. The load-response operation step may include operating the inverter compressor at a plurality of operating frequencies. In the stop operation step, the operating frequency compared with the stop frequency may be an operating frequency when the stop signal is input.

According to an embodiment of the present disclosure, a refrigerator includes a temperature sensor provided in a storage space of the refrigerator to detect a temperature; an inverter compressor constituting a freezing cycle for cooling the storage space, the number of rotations being variable by frequency control; and a controller for controlling the operation of the inverter compressor, and the controller may variably control the operating frequency of the inverter compressor according to the load of the storage space in order to maintain the storage space at a set temperature, and compare the operating frequency with a stop frequency when a stop signal is input, when the operating frequency is lower than the stop frequency, raise the frequency of the inverter compressor to the stop frequency, and then stop the inverter compressor. The stop frequency may be set to a value between 15% and 40% of a lower limit of an entire frequency range of the inverter compressor.

The controller may additionally operate the inverter compressor for a set time at the stop frequency and then stop the inverter compressor when the frequency of the inverter compressor has reached the stop frequency. When the stop signal is input, the operating frequency may be compared, with the stop frequency and when the operating frequency is higher than the stop frequency, the frequency of the inverter compressor may be lowered to the stop frequency and the inverter compressor may be then stopped. The refrigerator may include an operation part (or input device) for inputting a set temperature of the storage space by a user's operation, and when the temperature of the storage space satisfies the set temperature between 0° C. and 9° C., the stop signal may be input.

In the above description, numerous specific details are set forth in order to provide a thorough understanding of the present disclosure. The present disclosure may be practiced without some or all of these specific details. Examples of various embodiments have been illustrated and described above. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a refrigerator comprising:
performing a lubrication operation that includes operating a compressor at a first frequency after initiating the compressor;
performing, after the lubrication operation, a load-response operation that includes determining a second frequency of the compressor according to a load of a storage space of the refrigerator, and operating the compressor at the second frequency; and
performing a stop operation that includes comparing the second frequency with a third frequency when a stop condition occurs, and then increasing a frequency of the compressor to the third frequency and then stopping the compressor when the second frequency is less than the third frequency.

2. The method of claim 1, wherein the third frequency is set to a value between 15% and 40% of a lower limit of an entire frequency range of the compressor.

3. The method of claim 1, wherein the third frequency is set to a value between 10 Hz and 20 Hz.

4. The method of claim 1, wherein the third frequency is set lower than the first frequency.

5. The method of claim 1, wherein the stop operation includes operating the compressor for a set time at the third frequency and then stopping the compressor.

6. The method of claim 5, wherein the set time is set between 3 seconds and 10 seconds.

7. The method of claim 1, wherein the stop operation is performed when the stop condition occurs while the storage space is being refrigerated.

8. The method of claim 1, wherein the stop operation is performed when the stop condition occurs while a temperature of the storage space is in a range of 0° C. to 9° C.

9. The method of claim 1, wherein the stop operation is performed when the stop condition occurs while the refrigerator is operating in a kimchi storage mode.

10. The method of claim 1, wherein the stop operation includes decreasing the frequency of the compressor from the second frequency to the third frequency and then stopping the compressor when the second frequency is greater than the third frequency.

11. The method of claim 10, wherein the stop operation includes operating the compressor for a set time at the third frequency and then stopping the compressor after the set time.

12. The method of claim 1, wherein the stop condition occurs when a temperature inside the storage space satisfies a particular temperature or a particular temperature range.

13. The method of claim 1, wherein the first frequency and the third frequency are fixed regardless of an operating state of the refrigerator.

14. The method of claim 1, wherein the load-response operation includes operating the compressor at a plurality of second frequencies.

15. The method of claim 14, wherein the stop operation includes comparing the third frequency to one of the plurality of second frequency at which the compressor is operating when the stop condition occurs.

16. A method of controlling a compressor of a refrigerator, the method comprising:
initializing the compressor at a first frequency;
after initializing the compressor, operating the compressor at a second frequency that differs from the first frequency to cool a storage space of the refrigerator; and
changing the compressor from the second frequency to a third frequency, and then stopping the compressor.

17. The method of claim 16, wherein the compressor is operated for a set time at the third frequency before stopping the compressor.

18. The method of claim 17, wherein the compressor is initialized at a plurality of the first frequencies to lubricate the compressor.

19. The method of claim 16, wherein the compressor changes from the second frequency to the third frequency and then stops when a temperature in the storage space satisfies a particular temperature or a particular temperature range.

20. The method of claim 16, wherein the load-response operation includes operating the compressor at a plurality of the second frequencies to cool the storage space.
